(19) United States
(12) Patent Application Publication
(10) Pub. No.: US 2026/0186945 A1
(43) Pub. Date: Jul. 2, 2026

(54) COMPUTER ENVIRONMENT ANOMALY REMEDIATION

(71) Applicant: INTERNATIONAL BUSINESS MACHINES CORPORATION, Armonk, NY (US)

(72) Inventors: Hong Yi ZHANG, Beijing (CN); Zhan Peng HUO, Beijing (CN); Da Long WANG, Hangzhou (CN); Yu SUN, Shanghai (CN)

(21) Appl. No.: 19/003,430

(22) Filed: Dec. 27, 2024

(51) Int. Cl. G06F 11/07; G06F 11/34

(52) U.S. Cl. CPC G06F 11/3476; G06F 11/0751; G06F 11/079; G06F 11/0793

(57) ABSTRACT

Methods, computer program products, and systems are presented. The method computer program products, and systems can include, for instance: training a machine learning model with use of supervised learning, wherein the training includes applying to the machine learning model training data that includes historical logging data and historical metrics data of a computer environment, the training data being labeled with anomaly label data; inferencing the machine learning model for output of a data collection profile; processing current logging data and metrics data of the computer environment in dependence on one or more attribute of the data collection profile; identifying an anomaly of the computer environment in dependence on the processing; and performing an action for remediation of the anomaly.

### BACKGROUND

Embodiments herein relate generally to computer environments and specifically to anomalies of the computer environments.

IT logging data and metrics data can be used for monitoring, diagnosing, and optimizing system performance. Logging data includes system logs, error logs, security logs, and access logs, which track events, errors, and user activities across systems and networks. Metrics data, on the other hand, provides quantifiable indicators such as CPU usage, memory consumption, network throughput, system uptime, and security vulnerabilities. Together, these logs and metrics help ensure system reliability, security, and operational efficiency, enabling IT teams to respond proactively to issues and optimize system performance.

Data structures have been employed for improving operation of computer systems. A data structure refers to an organization of data in a computer environment for improved computer system operation. Data structure types include containers, lists, stacks, queues, tables and graphs. Data structures have been employed for improved computer system operation e.g., in terms of algorithm efficiency, memory usage efficiency, maintainability, and reliability.

Artificial intelligence (AI) refers to intelligence exhibited by machines. Artificial intelligence (AI) research includes search and mathematical optimization, neural networks and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

### SUMMARY

Shortcomings of the prior art are overcome, and additional advantages are provided, through the provision, in one aspect, of a method. The method can include, for example: training a machine learning model with use of supervised learning, wherein the training includes applying to the machine learning model training data that includes historical logging data and historical metrics data of a computer environment, the training data being labeled with anomaly label data; inferencing the machine learning model for output of a data collection profile; processing current logging data and metrics data of the computer environment in dependence on one or more attribute of the data collection profile; identifying an anomaly of the computer environment in dependence on the processing; and performing an action for remediation of the anomaly.

In another aspect, a computer program product can be provided. The computer program product can include a computer readable storage medium readable by one or more processing circuit and storing instructions for execution by one or more processor for performing operations. The operations can include, for example: training a machine learning model with use of supervised learning, wherein the training includes applying to the machine learning model training data that includes historical logging data and historical metrics data of a computer environment, the training data being labeled with anomaly label data; inferencing the machine learning model for output of a data collection profile; processing current logging data and metrics data of the computer environment in dependence on one or more attribute of the data collection profile; identifying an anomaly of the computer environment in dependence on the processing; and performing an action for remediation of the anomaly.

In a further aspect, a system can be provided. The system can include, for example, a memory. In addition, the system can include one or more processor in communication with the memory. Further, the system can include program instructions executable by the one or more processor via the memory to perform operations. The operations can include, for example: training a machine learning model with use of supervised learning, wherein the training includes applying to the machine learning model training data that includes historical logging data and historical metrics data of a computer environment, the training data being labeled with anomaly label data; inferencing the machine learning model for output of a data collection profile; processing current logging data and metrics data of the computer environment in dependence on one or more attribute of the data collection profile; identifying an anomaly of the computer environment in dependence on the processing; and performing an action for remediation of the anomaly.

Additional features are realized through the techniques set forth herein. Other embodiments and aspects, including but not limited to methods, computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a system having a remediation system, data sources, and an administrator client computer device according to one embodiment;

FIG. 2 depicts a computer system according to one embodiment;

FIGS. 3A-3B is a flowchart illustrating a method for performance by a manager system according to one embodiment;

FIG. 4A depicts a machine learning model according to one embodiment;

FIG. 4B depicts a machine learning model according to one embodiment;

FIG. 5 illustrating a method for performance by a remediation system according to one embodiment;

FIG. 6 depicts an artificial neural network (ANN) according to one embodiment;

FIG. 7 depicts a computing environment according to one embodiment.

### DETAILED DESCRIPTION

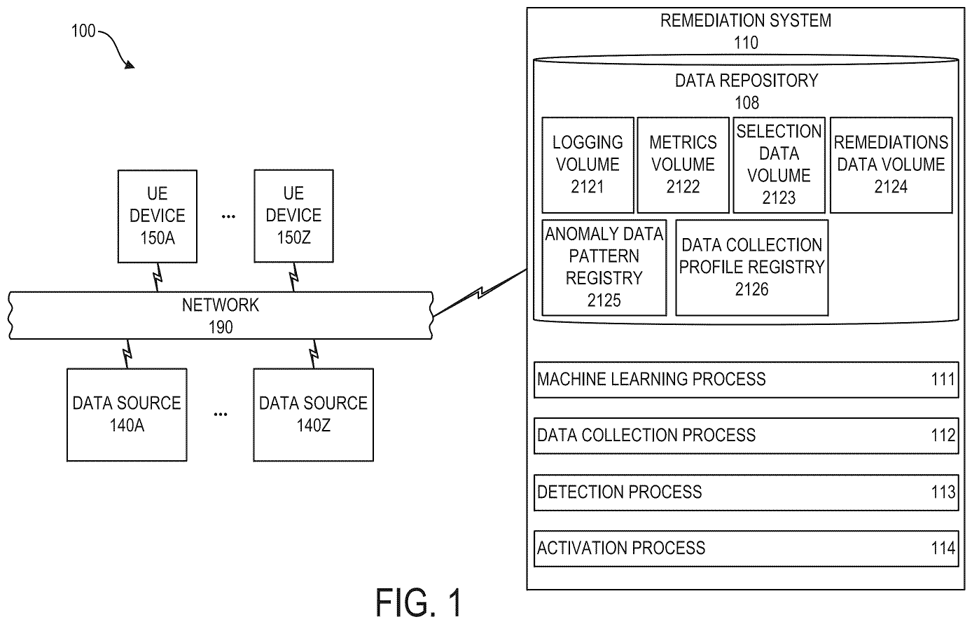

System 100 for remediation of anomalies in a computer environment is shown in FIG. 1. System 100 can include remediation system 110 having an associated data repository 108 data sources 140A-140Z for generating logging data and/or metrics data and user equipment (UE) devices 150A-150Z. Remediation system 110, data sources 140A-140Z and UE devices 150A-150Z can be computing node based systems in communication with one another via network 190. Network 190 can be a physical network and/or a virtual network. A physical network can be, for example, a physical telecommunications network connecting numerous computing nodes or systems, such as computer servers and computer clients. A virtual network can, for example, combine numerous physical networks or parts thereof into a logical virtual network. In another example, numerous virtual networks can be defined over a single physical network.

Data sources 140A-140Z can define sources of logging data defined by log messages and/or sources of metrics messages defined by metrics data messages. Data sources 140A-140Z can comprise e.g., logging agents of applications, which produce application log messages, logging agents of operating systems which include system log messages, logging agents which produce security log messages, logging agents which produce audit log messages, logging agents which produce transaction log messages, and logging agents which produce event log messages. Data sources 140A-140Z can comprise e.g., metrics generating agents producing various types of metrics data. IT metrics data can be various measurable indicators used to evaluate the performance, security, infrastructure, and user experience of IT systems. Key performance metrics can include system uptime, response time, throughput, and latency, all of which can help assess the operational efficiency of IT systems. Security metrics can focus on incident response time, the number of vulnerabilities, patch management, and intrusion detection rate, ensuring system security can be maintained. Application metrics, such as error rate, crash frequency, load time, and concurrent users, can track the reliability and performance of software applications. Infrastructure metrics can monitor the health of IT resources through measures like CPU utilization, memory usage, network bandwidth, and disk I/O. Service-level metrics, like mean time to resolution (MTTR), mean time between failures (MTBF), and service desk resolution times, can measure the efficiency of IT service delivery. Lastly, user experience metrics, like satisfaction rate, first call resolution, and system availability, can gauge how well IT services meet user expectations and demands. Together, these metrics can help organizations optimize their IT systems, improve service quality, and ensure security and efficiency.

UE devices 150A-150Z can include, e.g., laptops, tablets, PCs, smartphones, custom consoles associated to administrator users of system 100.

Embodiments herein recognize that in modern IT infrastructure large amounts of data can accompany an anomaly at the initiation thereof. Embodiments herein recognize that multiple events can be generated from the concurrently at the initiation of an anomaly. Embodiments herein recognize that operational data can include the log-based data, metric-based time series data generated from operating systems, applications, network devices and the like. Embodiments herein provide methodologies by which select observatory data can be selectively processing for fast, accurate and computing resource economized detection of an anomaly and/or root cause thereof. Embodiments herein provide methodologies for analyzing historical observatory data to discover the relationship based on sequential index set among various anomalies generated from the multi-dimensional observatory log data and metrics data to identify anomalies and/or root causes thereof.

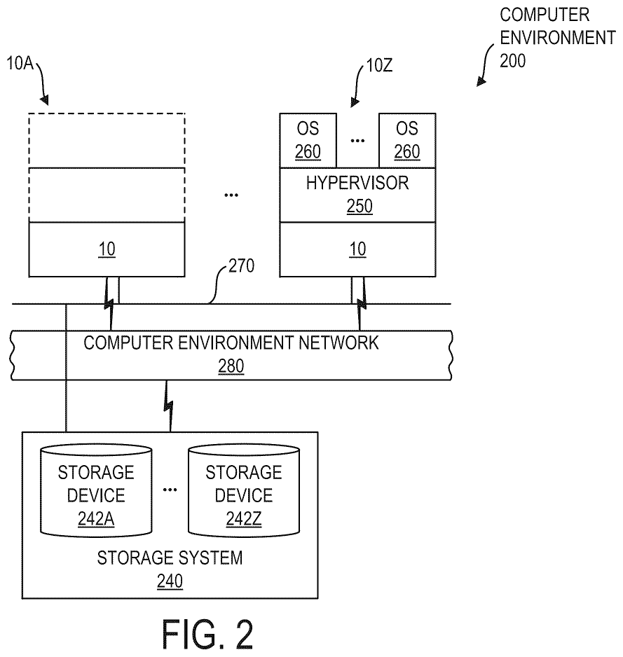

FIG. 2 depicts an example infrastructure defining a computer environment 200 for hosting remediation system 110 and which can be serviced, supported, and protected by remediation system 110. Computer environment 200 is set forth in reference to the infrastructure view of FIG. 2. Computer environment 200 can include a plurality of computing nodes 10, which can be provided by physical computing nodes. Remediation system 110 can be hosted on one or more computing node 10 of computer environment 200, e.g., via or without intermediary virtual machine (VM) software.

The respective computing nodes 10 can have software running thereon defining computing node stacks 10A-10Z. Software defining the respective instances of computing node stacks 10A-10Z can be differentiated between the computing node stacks, e.g. some stacks can provide traditional bare metal machine operation, other stacks can include a hypervisor 250 that supports a plurality of guest operating systems (OS) 260 defining respective guest hypervisor based virtual machines (VMs), other stacks can include container based VMs, e.g. running on top of a hypervisor based VM or running on a computing node stack that is absent of a hypervisor. A plurality of different configurations are possible. Software defining the respective instances of computing node stacks 10A-10Z can include application layer software which when run can perform various processes, e.g., processes of a storage system controller and/or processes 111-114 of remediation system 110.

Referring to further aspects of computer environment 200, computer environment 200 can include storage system 240. Storage system 240 can include storage devices 242A-242Z, which can be provided by physical storage devices. Physical storage devices of storage system 240 can include associated controllers defined by one or more computing node stack of computing node stacks 10A-10Z. Storage devices 242A-242Z can be provided, e.g., by hard disks and Solid-State Storage Devices (SSDs). Storage system 240 can be in communication with computing node stacks 10A-10Z by way of a Storage Area Network (SAN) and/or a Network Attached Storage (NAS) link. According to one embodiment, computer environment 200 can include fibre channel network 270 providing communication between respective computing node stacks 10A-10Z and storage system 240. Fibre channel network 270 can include a physical fibre channel that runs the fibre channel protocol to define a SAN. NAS access to storage system 240 can be provided by computer environment network 280 which can be an IP based network. Network 190 set forth in the logical system view of FIG. 1 can be defined by one or more of fibre channel network, and/or computer environment network 280. Computer environment 200 can be configured to provide cloud computing services. Computer environment 200 can be provided, e.g., by one or more data center.

In one embodiment, volumes 2121-2124 and registries 2125-2126 can map in infrastructure space to one or more storage device of storage devices 242A-242Z.

Data sources 140A-140Z can be provided e.g. by logging agents disposed appropriately within computer environment 200 for generating log messages, e.g. application log messages, system log messages, security log messages, audit log messages, transaction log messages, and event log messages. Data sources 140A-140Z (FIG. 1) can comprise e.g., logging agents of applications, which produce application log messages, logging agents of operating systems which include system log messages, logging agents which produce security log messages, logging agents which produce audit log messages, logging agents which produce transaction log messages, and logging agents which produce event log messages. Data sources 140A-140Z can additionally or alternatively be provided, e.g., by metrics data generating agents that generate metrics data of one or more of the metrics data types herein.

Data repository 108 can store various data. Data repository 108 in logging volume 2121 can store logging data. Logging data can include, e.g., the described logging data that can be output by data sources 140A-140Z. Data repository in metrics volume 2122 can store metrics data. Metrics data can include, e.g., the described metrics data that can be output. Stored logging data and stored metrics data can be timestamped.

Data repository 108 within selection data volume 2123 can store selection data specified by administrator users during a deployment period of remediation system 110. Selection data can include, e.g., selection data specifying administrator observed anomalies and associated root causes. From time to time, administrator users can observe anomalies within computer environment 200 as set forth in FIG. 2. Remediation system 110 can present, e.g., web-based user interfaces on UE devices 150A-150Z that permits administrator users to specify root causes with respect to various observed anomalies. In respect to such observed and specified anomalies and associated root causes, administrator users can further specify remediations that have been applied with respect to such observed anomalies and root causes. Additionally or alternatively, remediation system 110 can be configured to automatically ascertain applied remediations activated with respect to administrator user observed anomalies and root causes by analysis of data within logging volume 2121 and/or metric volume 2122. Selection data stored within selection data volume 2123 can be entered by administrator users into user interfaces presented on UE devices 150A-150Z associated to various ones of the described administrator users.

Data repository 108 in remediations data volume 2124 can store data specifying remediations applied by computer environment 200 with respect to administrator user observed anomalies and specified root causes. Remediations data volume 2124 can include data specifying applied remediations applied to computer system 200 in respect to historical administrator observed anomalies and root causes and can optionally include performance data associated to such applied remediations. The performance data can be specified, e.g., by administrator users and/or can be automatically determined by remediation system 110. Remediation system 110 can be configured so that when remediations data volume 2124 is queried with a root cause or anomaly identifier, remediations data volume 2124 returns an ordered list of identifiers for top performing remediations for the anomaly and root cause.

In one embodiment, remediation system 110 can automatically ascertain remediation performance data by inferencing a trained machine learning model that has been trained by training data that specifies performance data of computer environment 200 with respect to an applied remediation applied with respect to an historical anomaly and root cause of computer system.

Data repository in anomaly data pattern registry 2125 can store anomaly data patterns output by remediation system 110 running machine learning process 111. In one aspect, remediations system 110 can run machine learning process 111 to output anomaly data patterns. Anomaly data patterns herein refer to patterns of observatory data, e.g., metrics data and/or logging data indicative of an anomaly occurring. As set forth herein, remediation system 110 can run machine learning process 111 for processing of historical observatory data for output of anomaly data patterns for storage into anomaly data pattern registry 2125.

Data repository 108 in data collection profile registry 2126 can store data specifying data collection profiles that have been identified by remediation system 110. In one aspect, remediation system 110 can run machine learning process 111 to process historical observatory data for output of data collection profiles. Data collection profiles herein can include a set of observatory data flags that can be detected by remediation system 110 for identification of a certain anomaly and associated root cause.

Remediations system 110 can be configured to run various processes. Remediation system 110 running machine learning process 111 can include remediation system 110 training and inferencing of one or more machine learning model. In one aspect, remediation system 110 running machine learning process 111 can train and inference a machine learning model for output of one or more anomaly data pattern and/or one or more data collection profile. For training such machine learning model, remediation system 110 running machine learning process 111 can apply as training data historical observatory data associated to label data, wherein the label data is defined by the described anomaly and root cause labels set forth in reference to selection data volume 2123. An output anomaly data pattern herein can define a data structure conforming to a format of an anomaly data structure template.

Training data can include a combination of logging data and metrics data. Logging data and metrics data serve different purposes in system monitoring. Logging data captures detailed, event-based information, such as errors, user actions, and system events, with high granularity, making it ideal for debugging, troubleshooting, and auditing specific occurrences. In contrast, metrics data focuses on quantifying system performance through aggregated numerical values like CPU usage or response times, providing a high-level overview of system health for trend analysis and real-time monitoring. While logs are often unstructured and generate larger volumes of data, metrics are structured as time-series data with lower volume, designed for long-term retention and visualized through dashboards for ongoing performance monitoring. Tools like ELK Stack and Splunk are used for logs, while Prometheus and Grafana are common for metrics collection and visualization.

Trained as described, the described machine learning model can learn a relationship between administrator user observed anomalies and root causes and observatory data parameters associated to such anomalies and root causes, as well as time periods of interest associated to such observatory data. Upon training of the described machine learning model, the machine learning model can be inferenced for return of one or more anomaly data pattern and/or one or more data collection profile.

Remediations system 110 running machine learning process 111, in one aspect, can include remediation system 110 training and inferencing a machine learning model trained for producing predictions as to optimized and best performing remediations associated to root causes. Machine learning models herein can be referred to as predictive machine learning models.

Remediations system 110 running data collection process 112 can include remediation system 110 performing data collection in accordance with an activated data collection profile. When a data collection profile is active, remediation system 110 can selectively perform data structuring of specific data parameter values that have been specified in a data collection profile. The outputting of a data collection profile by remediation system 110 performing machine learning process 111 economizes computing resources, i.e. with use of a data collection profile remediation system 110 can detect and perform structuring of only select observatory data that is specified in a data collection profile thus facilitating an accurate detection of anomalies with reduced utilization of computing resources. Observatory data herein can include logging data and/or metrics data.

Remediation system 110 running data collection process 112 can further include remediation system 110 applying select historical data for use in training one or more machine learning model.

Remediation system 110 running detection process 113 can include remediation system 110 comparing live current real-time observatory data collected with use of a data collection profile to one or more anomaly data pattern stored in anomaly data pattern registry 2125.

Remediation system 110 running activation process 114 can activate one or more remediation in response to a detected anomaly detected by use of detection process 113. In one embodiment, the best and prioritized one or more remediation can be determined based on machine learning training of a machine learning model to predict a best one or more performing remediation associated to an historical anomaly.

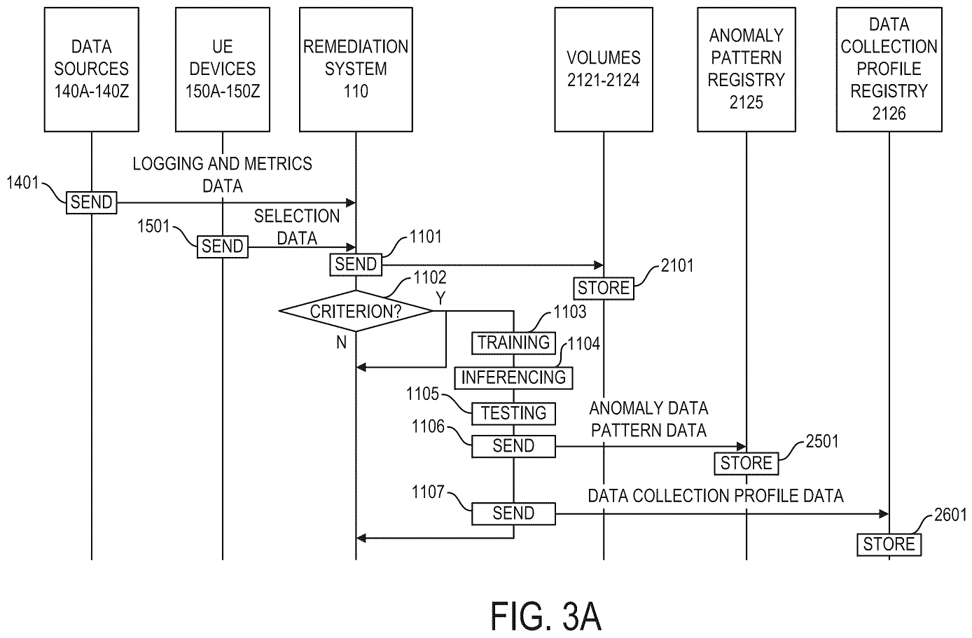

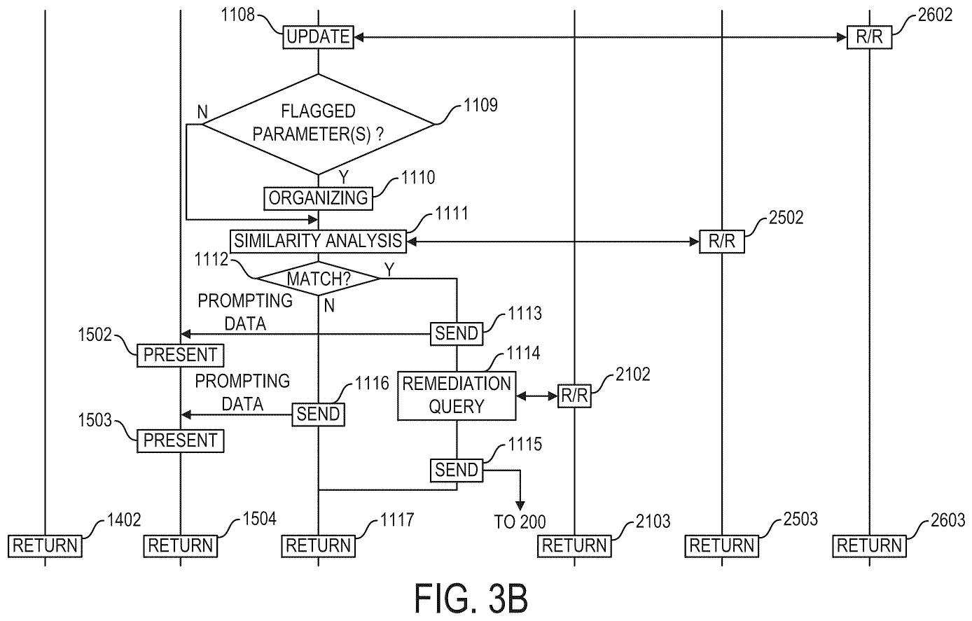

A method for performance by remediation system 110 interoperating with data sources 140A-140Z, UE devices 150A-150Z, volumes 2121 to 2124, anomaly pattern registry 2125, and data collection profile registry 2126 is set forth in reference to the flowchart of FIG. 3A to 3B.

At send block 1401, data sources 140A-140Z can be sending observatory data. The observatory data can be provided by logging data and/or metrics data and the observatory data sent at block 1401 can be sent for receipt by remediation system 110 at send block 1501. UE devices 150A-150Z can be sending selection data. Selection data defining election data specified at send block 1501 can include administrator user specified selection data that specifies observed anomalies and associated root causes associated to administrator of computer environment 200 with a timestamp associated to the administrator observed anomaly and/or root cause. In one embodiment, the timestamp of an administrator determined anomaly and/or root cause can be a timestamp that specifies an initiation time of a determined anomaly. Selection data can additionally or alternatively include administrator user specified remediation data, which remediation data can additionally or alternatively be provided by automated processes herein.

On receipt of the logging and metrics data sent at send block 1401 and selection data sent at send block 1501, remediation system 110 at send block 1101 can send the logging metrics data and selection data to volumes 2121 to 2124 for storage therein. Logging data can be stored within logging volume 2121, metrics data can be stored within metrics volume 2122, selection data can be stored within selection data volume 2123, and remediation data can be stored within remediations data volume 2124.

On completion of send block 1101, remediation system 110 can proceed to criterion block 1102. At criterion block 1102, remediation system 110 can ascertain whether a criterion for proceeding with training of a machine learning model has been satisfied. In one example, remediation system 110 can ascertain that criterion block 1102 is satisfied when new selection data has been sent at a most recent iteration of send block 1501 that specifies one or more anomaly label defined by an administrator user of remediation system 110, which anomaly label can have associated thereto an administrator user defined root cause label.

On determining at criterion block 1102 that criterion for performing training of machine learning model has been satisfied, remediation system 110 can proceed to training block 1103 to perform training of a machine learning model. Training at training block 1103 can include initially training a machine learning model or further training a previously trained machine learning model.

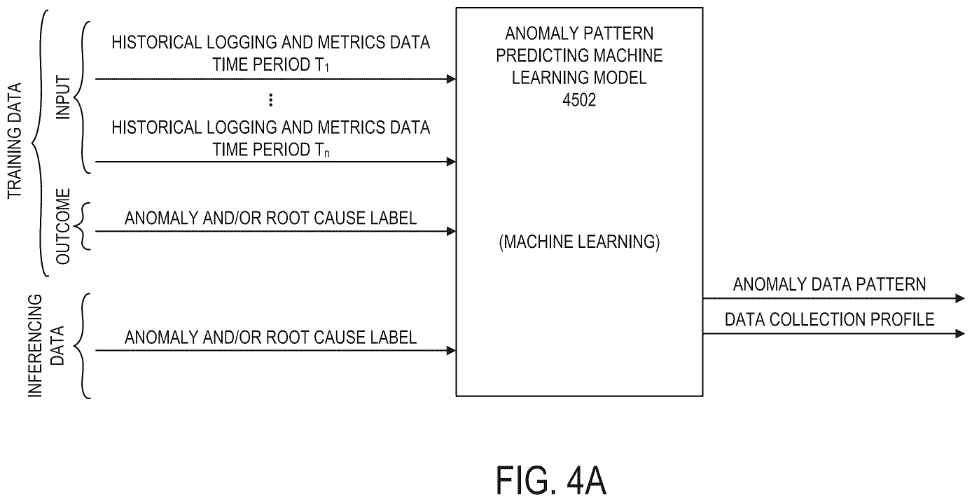

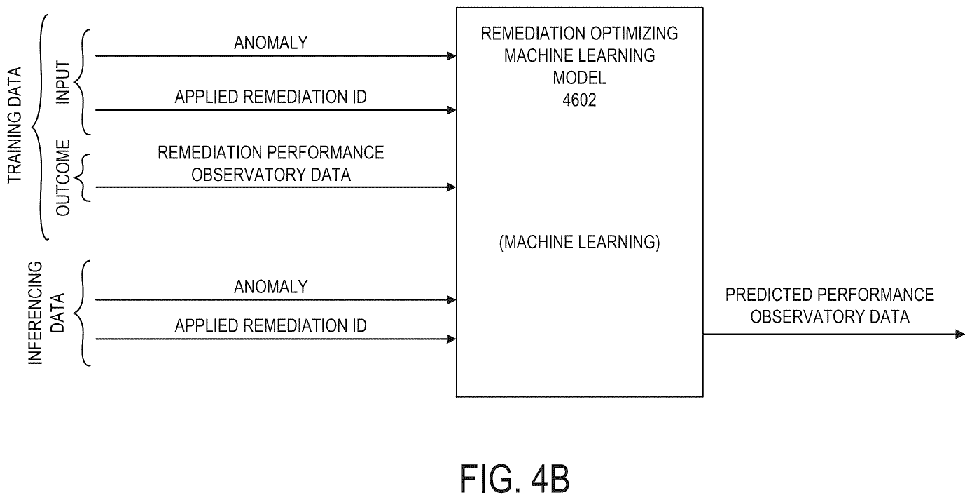

At training block 1103, remediation system 110 can perform training of anomaly pattern predicting machine learning model 4502 as set forth in FIG. 4A. For training of anomaly pattern predicting machine learning model 4502, remediation system 110 can look up all administrator user defined anomaly and/or root cause labels associated to administrator user observed anomalies that have been stored within selection data volume 2123 of data repository 108. In system 100, administrator user defined anomaly and/or root cause labels can define a ground truth for purposes of training.

For each administrator user observed and defined anomaly and/or associated root cause, remediation system 110 can apply an iteration of training data as set forth in respect to anomaly pattern predicting machine learning model 4502 shown in FIG. 4A. Remediation system 110, for each anomaly and/or root cause label stored within selection data volume 2123, apply training data that comprises a component of input training data and a component of outcome training data.

The input training data for associated to an administrator user defined anomaly and/or root cause label can include combined historical logging data and metrics data for time periods T1 to Tn. Time periods T1 to Tn can include historical time periods about and associated to, e.g., within a time window, of the timestamp of the administrator user specified anomaly and/or root cause label associated to the current training iteration. Time periods T1 to Tn can include subsets of time periods having a common duration and subsets of time periods having differentiated durations. Time periods T1 to Tn can include subsets of time periods having common start times and subsets of time periods having differentiated (staggered) start times. The historical logging data associated to an administrator user defined anomaly and/or root cause label can include a superset of all logging data parameters and metrics data parameters that can be potentially predictive of the anomaly and/or root cause label of the administrator user. Training anomaly pattern predicting machine learning model 4502 can include training so that anomaly pattern predicting machine learning model 4502 filters out and removes logging data parameters and metrics data parameters so that only the most relevant logging data parameters and metrics data parameters are evaluated for predicting the presence of an anomaly in a current state of computer environment. Thresholding can be used for identification and filtering out for removal of less relevant parameters.

In applying historical logging and metrics data for training anomaly pattern predicting machine learning model 4502, remediation system 110 can organize historical logging and metrics data so that the applied training data for training conforms to the format of a template anomaly data structure, an example of which is shown in Table A.

TABLE A

```
{
“rootCause”: “undefined”,
“anomalyName”: “undefined”,
“anomalyNodes”: [
  {
    “timeDiff”: “undefined”,
    “anomalyLogs”: [
      {
          “logKey”: “undefined”,
          “timeStamp”: “undefined”,
          “logText”: “undefined”
      },
      {
          “logKey”: “undefined”,
          “timeStamp”: “undefined”,
          “logText”: “undefined”
      },
      {
          ...
      },
      ...
    ],
    “anomalyMetrics”: [
        {“metricName”: “undefined”,
              “metricRange”: [MinValue, MaxValue],
              “actualValue”: “undefined”,
              “weight”: “undefined”
        },
        {
              “metricName”: “undefined”,
              “metricRange”: [MinValue, MaxValue],
              “actualValue”: “undefined”,
              “weight”: “undefined”
        },
        {
              “metricName”: “undefined”,
              “metricRange”: [MinValue, MaxValue],
              “actualValue”: “undefined”,
              “weight”: “undefined”
        },
        {
                ...
        },
        ...
    ]
  },
  {
    “timeDiff”: “undefined”,
    “anomalyLogs”: [
      {
          “logKey”: “undefined”,
          “timeStamp”: “undefined”,
          “logText”: “undefined”
      },
      {
          “logKey”: “undefined”,
          “timeStamp”: “undefined”,
          “logText”: “undefined”
      },
      {
            ...
      },
      ...
    ],
    “anomalyMetrics”: [
      {
          “metricName”: “undefined”,
          “metricRange”: [MinValue, MaxValue],
          “actualValue”: “undefined”,
          “weight”: “undefined”
      },
      {
          “metricName”: “undefined”,
          “metricRange”: [MinValue, MaxValue],
          “actualValue”: “undefined”,
          “weight”: “undefined”
      },
      {
          “metricName”: “undefined”,
          “metricRange”: [MinValue, MaxValue],
          “actualValue”: “undefined”,
          “weight”: “undefined”
      },
      {
          ...
      },
      ...
      ]
  },
  {
      ...
  },
  ...
]
}
```

According to the template anomaly data structure of Table A, collected data associated to an anomaly can include a combination of logging data and metrics data. Embodiments herein recognize that predictions in regard to IT anomalies can be improved by combining of both logging data and metrics data, which logging data and metrics data can define differentiated perspectives on a common problem. In one aspect combined logging and metrics data can be used to train anomaly pattern predicting machine learning model 4502 which on being trained can be inferenced for return of one or more anomaly data pattern having combined logging and metrics and which can be further inferenced for return of one or more data collection profile defining a method for processing live current real time logging data and metrics data.

Trained as described, anomaly pattern predicting machine learning model 4502 learns of a relationship between administrator user defined anomaly and/or root cause labels and logging data and metrics data datasets that are predictive of the labels, as well as time periods most predictive of an anomaly. Anomaly pattern predicting machine learning model 4502 can be trained so that anomaly pattern predicting machine learning model 4502 learns logging data parameters, metrics data parameters and time periods most predictive of anomaly and/or root cause labels.

Anomaly pattern predicting machine learning model 4502 can be trained with iterations of training data. In one example, there can be, e.g., tens, hundreds, thousands, millions of administrator user defined anomaly and/or root cause labels stored within selection data volume 2123. For each administrator specified anomaly and/or root cause label stored in selection data volume 2123, remediation system 110 at training block 1103 can apply an iteration of training data as depicted in FIG. 4A. For configuring anomaly pattern predicting machine learning model 4502 to provide predictions as to prominent data sets associated to certain anomaly and/or root cause label, anomaly pattern predicting machine learning model 4502 can be trained with multiple iterations of training data associated to the certain anomaly and/or root cause label. Anomaly pattern predicting machine learning model 4502 can be similarly trained with multiple iterations of training data associated to multiple different anomaly and/or root cause labels.

To train a neural network so that it learns the most important parameters of a training dataset while dropping less significant ones, a combination of techniques can be utilized. The choice of loss function in one embodiment can guides how the network updates its weights to minimize prediction errors. Loss functions like mean squared error (MSE) or cross-entropy can be used depending on the task. To encourage the network to focus on relevant features, regularization methods like L1 (lasso) and L2 (ridge) regularization can be applied. L1 regularization helps by promoting sparsity, driving less important weights to zero and effectively “dropping” unimportant parameters, while L2 regularization reduces overfitting by penalizing large weights, though without forcing weights to zero. Combining these methods, Elastic Net regularization can balance both sparsity and weight minimization, enabling the network to drop irrelevant features while still constraining the remaining ones. In one embodiment dropout can be employed. Dropout refers to a regularization technique that randomly “drops” neurons during training, forcing the network to rely less on specific parameters and more on distributed patterns, which helps it learn which parameters are truly important over time. Complementing this, feature selection techniques such as gradient-based importance scores or permutation-based methods can highlight which features matter most for prediction accuracy, allowing for either dataset modification or network architecture adjustments to further emphasize those important features. In one embodiment, dimensionality reduction techniques like Principal Component Analysis (PCA) or autoencoders can also help by pre-processing the input data to reduce noise and focus on the key components. More advanced models can incorporate attention mechanisms, which allow the network to dynamically focus on the most relevant parts of the input data, assigning higher weights to significant features and reducing the influence of less relevant ones. Throughout the training process, optimization techniques and proper hyperparameter tuning (e.g., adjusting learning rates) can be employed so that the model converges toward a solution that prioritizes important features without overfitting. Together, one or more of the described techniques, e.g., regularization, dropout, feature selection, dimensionality reduction, attention mechanisms can be utilized to guide the neural network to focus on the most critical parameters in the dataset, effectively minimizing or “dropping” those that are less useful.

When training a neural network with a dataset that includes parameters from different time periods, the goal is to ensure the model learns the most important temporal features while dropping less relevant ones. This can be achieved by using time-specific architectures like Recurrent Neural Networks (RNNs), Long Short-Term Memory (LSTM) networks, or Temporal Convolutional Networks (TCNs), which are designed to capture temporal dependencies in time-series data. The loss function can be enhanced with temporal weighting or window-based optimization to prioritize specific time periods, penalizing errors more heavily for important intervals. Regularization techniques like L1 regularization encourage sparsity, which can drive less important time-related weights to zero, while L2 regularization penalizes large weights and helps the network generalize across time periods. Elastic Net combines both approaches to balance weight minimization and sparsity. Attention mechanisms, such as those found in Transformer models, can be employed to allow the network to automatically focus on the most critical time periods by assigning higher weights to relevant intervals. Temporal dropout can be used to prevent overfitting by randomly dropping time-related features, encouraging the model to learn distributed representations and forcing it to focus on more meaningful time periods. Feature engineering techniques, such as creating lag features or applying rolling windows, can help the model learn broader temporal patterns and reduce noise from irrelevant periods. Dimensionality reduction methods like Principal Component Analysis (PCA) or autoencoders can further help reduce the dimensionality of time-related features, ensuring that only the most important time intervals are retained before training. Finally, careful optimization and hyperparameter tuning, such as adjusting the learning rate, batch size, and sequence length, can help the model efficiently capture important time-related features without overfitting to less relevant periods. By combining these approaches—time-specific architectures, loss function enhancements, regularization, attention mechanisms, dropout, feature engineering, and dimensionality reduction—the neural network can be trained to emphasize the most important time periods in the dataset while minimizing or dropping less significant temporal parameters.

On completion of training at training block 1103, remediation system 110 can proceed to inferencing block 1104. Anomaly pattern predicting machine learning model 4502, once trained can be responsive to inferencing data. Inferencing data for inferencing anomaly pattern predicting machine learning model 4502 can include an anomaly and/or root cause label. Anomaly pattern predicting machine learning model 4502 can be inferenced with inferencing data defined by an anomaly and/or root cause labels stored in selection data volume. When inferenced with an anomaly and/or root cause label, anomaly pattern predicting machine learning model 4502 can output (a) an anomaly data pattern associated to the anomaly and/or root cause label and (b) a data collection profile associated to the anomaly and/or root cause label. The output anomaly data pattern and the output data collection profile can map to a common anomaly and/or root cause label. In one embodiment, remediation system 110 can be configured so that when a certain data collection profile for a certain anomaly is active, remediation system 110 processes incoming live current real time logging data that is processed using the certain data collection profile only for detection of the certain anomaly and not other anomalies, thus economizing the utilization of computing resource which might otherwise be wasted on detection of anomalies unrelated to the certain data collection profile. In other use cases, remediation system 110 can attempt to match all observatory data pattern data structures to all anomaly data patterns stored in data repository 108.

At inferencing block 1104, remediation system 110 can apply inferencing data for each anomaly and/or root cause label that has been previously stored within selection data volume 2123. At inferencing block 1104, anomaly pattern predicting machine learning model 4502 can output a different anomaly data pattern and data collection profile pair for each anomaly and/or root cause label applied as inferencing data.

On completion of inferencing block 1104, remediation system 110 can proceed to testing block 1105. At testing block 1105, remediation system 110 can qualify select ones of the output anomaly data pattern and data collection profile pairs output at inferencing block 1104. At testing block 1105, remediation system 110 can qualify an anomaly data pattern and data collection profile pair based on a confidence level associated to the anomaly data pattern and data collection profile. Anomaly pattern predicting machine learning model 4502 can be configured to output a confidence level associated to each prediction output by anomaly pattern predicting machine learning model 4502. The confidence level, in one embodiment, can be based on a volume of training data applied for return of a particular prediction, e.g. a prediction of a certain anomaly data pattern and data collection profile associated to a certain anomaly and/or root cause label.

On completion of testing block 1105, remediation system 110 can proceed to send block 1106 and send block 1107. In one aspect, anomaly pattern predicting machine learning model 4502 can be trained to identify most relevant logging and metrics data parameters, and time periods and filter out least relevant logging and metrics data parameters and time periods.

The historical logging data of time periods TL1 to TLn in the historical metrics data of the time periods TM1 and TMn can include, in one embodiment, a superset of logging data or metrics data potentially predictive of an anomaly and/or root cause label, e.g., all or essentially all available logging data or metrics data that have been produced by computer system 200 being supported within a time window of an anomaly and/or root cause timestamp.

Attributes of an illustrative anomaly data pattern are described in Table B.

TABLE B
The anomaly data pattern can feature a linked list data structure to generate an anomaly workflow. The
linked list can include multiple nodes to describe the workflow of a certain anomaly wherein each node
specifies characteristics of logging data and metrics data predictive of the certain anomaly. Every
anomaly node can include the below fields that combine logging data and metrics data:
1> timeDiff: the time difference from the anomaly is detected.
2> anomalyLogs: Describe the anomaly log messages from the different component or microservices.
It includes the fields “logKey”, “timestamp” and “logText”. Logkey is the anomaly log key, timestamp
is the actual time that anomaly log is detected, and logText is the anomaly log message.
3> anomalyMetrics: Describe the anomaly metrics from the different component or microservices. It
includes the fields “metricName”, “metricRange”, “actualValue” and “weight”. metricName is the
anomaly metric name, metricRange is metric value range, and weight is the anomaly weight for this
metric.

In outputting an anomaly data profile, remediation system can output an anomaly data pattern in a data structure format having the format of the template anomaly data structure of Table A having combined and organized logging data and metrics data. An example of an output anomaly data pattern is shown in Table C.

TABLE C

```
{
  “anomalypatternID”: 100023302,
  “rootCause”: “Out of Memory”,
  “anomalyName”: “event 1”,
  “anomalyNodes”: [
    {“timeDiff”: “0”,
      “anomalyLogs”: [{
        “logKey”: “SYS001E”,
        “timeStamp”: “21:00:01”,
        “logText”: “System memory utilization is higher than 70%”
      },{
        “logKey”: “CICS001E”,
        “timeStamp”: “21:00:02”,
        “logText”: “CICS region 1 memory utilization is higher than 50%”
      }],
      “anomalyMetrics”: [
        {“metricName”: “memUtil”,
          “metricRange”: [“1.1”, “1.2”],
          “actualValue”: “0.4”,
          “weight”: “0.7”
        }, {
          “metricName”: “cicsUtil”,
          “metricRange”: [“1.1”, “1.2”],
          “actualValue”: “0.4”,
          “weight”: “0.7”
        }, {
          “metricName”: “db2Util”,
          “metricRange”: [“1.1”, “1.2”],
          “actualValue”: “0.4”,
          “weight”: “0.7”
        }]
    }, {
      “timeDiff”: “10s”,
      “anomalyLogs”: [{
        “logKey”: “DB2ERR001”,
        “timeStamp”: “21:00:05”,
        “logText”: “DB2 buffer pool is larger than 80%”
      },{
        “logKey”:”MQERR003”,
        “timeStamp”: “21:00:07”,
        “logText”: “The depth of Queue Q1 is larger than 1000”
      }],
      “anomalyMetrics”: [
        {“metricName”: “db2BufferPool”,
          “metricRange”: [“1.1”, “1.2”],
          “actualValue”: “0.4”,
          “weight”: “0.7”
        }, {
          “metricName”: “queueDepth”,
          “metricRange”: [“1.1”, “1.2”],
          “actualValue”: “0.4”,
          “weight”: “0.7”
        }, {
          “metricName”: “queueRate”,
          “metricRange”: [“1.1”, “1.2”],
          “actualValue”: “0.4”,
          “weight”: “0.7”
        }]
    }]
}
```

The data collection profile stored in data collection profile registry 2126 can include data specifying a data collection profile name, a time span that specifies how long a period of data will be collected, a metrics specifier that specifies collected metrics that contain multiple components, an interval specifier that specifies the frequency that metrics data has collected, and a log key specifier that specifies keywords collected in log data.

A data collection profile herein can be provided by a data structure that defines how to collect live current real time log data and metrics data from source log file and metric data. A data collection profile can include, e.g., i> Name: Data collection name; ii> span time: How long period of data will be collected; iii> Metrics: The collected metrics that contains multiple components; iv> interval: the frequency that metrics data is collected; v> logKeys: The keywords collected in the log data when anomaly is detected.

An example of an output data collection profile is set forth in Table D.

```
TABLE D
{
    “metrics”: {
        “interval”: “5mins”,
        “collectedMetrics”: [“sysMemUtil”, “cicsMemUtil”, “db2MemUtil”, “mqMemUtil”,
  “appMemUtil”]
    },
    “logs”: {
      “spanTime”: “1h”,
      “collectedLogKeys”: [“sysLogKey”, “cicsLogKey”, “db2LogKey”, “mqLogKey”,
  “appLogKey”]
    }
}
```

Anomaly pattern predicting machine learning model 4502 can be trained so that anomaly pattern predicting machine learning model 4502 identifies and isolates most relevant logging data, the most relevant metrics data, and the most relevant time periods for such most relevant logging data and most relevant metrics data. Anomaly pattern predicting machine learning model 4502 can be trained so that anomaly pattern predicting machine learning model 4502 filters out least relevant logging data and least relevant metrics data and least relevant time periods such that the filtered out and least relevant logging data metrics data and time periods can be excluded from the output anomaly data pattern as shown in Table A, and the output data collection profile as shown in Table B.

At send block 1106, remediation system 110 can send qualified anomaly data patterns for storage into anomaly data pattern registry 2125 at store block 2501 and at send block 1107 remediation system 110 can send qualified data collection profiles for storage in data collection profile registry 2126. Each qualified anomaly data pattern can be associated to a respective anomaly and/or root cause label. Likewise, each qualified data collection profile stored at store block 2601 can be associated to a respective anomaly and/or root cause label.

On determination at criterion block 1102 that training is not to be performed, remediation system 110 can proceed to update block 1108. Remediation system 110 can additionally, in some embodiments, proceed to update block 1108 irrespective of whether training is triggered at criterion block 1102, i.e., can proceed to update block 1108 while simultaneously performing training.

At update block 1108, remediation system 110 can activate each qualified data collection profile that has been output at a most recent iteration of testing block 1105 and send block 1107. For performance of update block 1108, remediation system 110 can query data collection profile registry 2126 as indicated by receive and respond block 2602 of data collection profile registry 2126. By the activation of select and qualified data collection profiles at update block 1108, remediation system 110 can avoid live real-time organizing into a data structure logging data and metrics data parameters not referenced in the activated data collection profiles activated update block 1108. Thus, at update block 1108, remediation system 110 can economize computing resource utilization by activating of live real time data structure data organizing of only select data. With all qualified data collection profiles active, remediation system 110 can proceed to flagged parameter(s) decision block 1109.

Accordingly, there is set forth herein, according to one embodiment training a machine learning model with use of supervised learning, wherein the training includes applying to the machine learning model training data that includes historical logging data and historical metrics data of a computer environment, the training data being labeled with anomaly label data; inferencing the machine learning model for output of a data collection profile; processing current logging data and metrics data of the computer environment in dependence on one or more attribute of the data collection profile; identifying an anomaly of the computer environment in dependence on the processing; and performing an action for remediation of the anomaly. There is also set forth herein, for example, performing the training to filter out observatory data parameters of the historical logging data and historical metrics data so that certain observatory data parameters of the historical logging data and historical metrics data are identified by the training, wherein the data collection profile references the certain observatory data parameters of the historical logging data and historical metrics data, wherein the processing current logging data and metrics data of the computer environment in dependence on one or more attribute of the data collection profile includes selectively organizing certain observatory data of the current logging data and metrics data in dependence on a determination of the certain observatory data is observatory data of the certain observatory data parameters. There is also set forth herein, for example, the data collection profile being configured so that the data collection profile references a set of observatory data parameters, and wherein the processing current logging data and metrics data of the computer environment includes determining that current observatory data of the current logging data and metrics data is included in the set of observatory data parameters, responsively organizing the current observatory data into a current observatory data pattern data structure, wherein the inferencing the machine learning model includes inferencing the machine learning model for output of an anomaly data pattern and wherein the method includes storing the anomaly data pattern into a data repository, and wherein the method includes determining a similarity between the current observatory data pattern data structure and the anomaly data pattern, wherein the identifying the anomaly of the computer environment in dependence on the processing includes performing the identifying in dependence on the determining the determining the similarity between the current observatory data pattern data structure and the anomaly data pattern.

At flagged parameter(s) decision block 1109, remediation system 110 can examine incoming real-time logging and metrics data sent at block 1401. At flagged parameter(s) decision block 1109, remediation system 110 can detect by the examining of real-time logging data and metrics data sent at block 1101, whether an incoming logging data and/or metrics data parameter matches a parameter specified on an active data collection profile.

Logging and/or metrics data parameters detected for at flagged data decision block 1109 can include parameters that are specified within one or more data collection profile that has been activated at update block 1108. On the detection of a flagged parameter (i.e., a logging data parameter or metrics data parameter of an activated data collection profile), remediation system 110 can perform organizing of a current observatory data pattern data structure at organizing block 1110.

Organizing a current observatory data pattern data structure at organizing block 1110 can include organizing the current observatory data pattern data structure in accordance with an anomaly data structure template as set forth in Table A so that the current observatory data pattern data structure is in a data structure format comparable to a data structure format of anomaly data patterns stored within anomaly pattern registry 2125, which anomaly data patterns can also conform to the format of the template anomaly data structure as shown in Table A.

Embodiments herein recognize that current observatory data pattern data structures for comparison to anomaly patterns of anomaly pattern registry 2125 can be organized and structured over multiple iterations of decision block 1109 and organizing block 1110.

On the ascertaining at flagged parameter(s) decision block 1109 that a flagged parameter has not been detected, remediation system 110 can bypass organizing block 1110 and can proceed to similarity analysis block 1111. On completion of organizing block 1110, remediation system 110 can proceed to similarity analysis block 1111.

At similarity analysis block 1111, remediation system 110 can perform a similarity analysis between all current observatory data pattern data structures at their state of completion as of the most recent iteration of organizing block 1110 with respect to all qualified anomaly patterns stored within anomaly pattern registry 2125 as of the most recent iteration of store block 2501.

At similarity analysis block 1111, remediation system 110 can perform multiple queries on anomaly pattern registry 2125 as is indicated by receive and respond block 2102.

On completion of similarity analysis block 1111, remediation system 110 can proceed to match block 1112. At match block 1112, remediation system 110 can ascertain whether a current observatory data pattern data structure it its state as of a most recent iteration of organizing block 1110 matches an historical anomaly pattern stored within anomaly pattern registry 2125. An output anomaly data pattern and data collection profile pair output at blocks 1105-1007 can map to a common anomaly and/or root cause label.

In one embodiment, remediation system 110 can be configured so that when a certain data collection profile for a certain anomaly is active, remediation system 110 processes incoming live current real time logging data that is processed using the certain data collection profile only for detection of the certain anomaly and not other anomalies, thus economizing the utilization of computing resource which might otherwise be wasted on detection of anomalies unrelated to the certain data collection profile. In other use cases, remediation system 110 can attempt to match all observatory data pattern data structures to all anomaly data patterns stored in data repository 108.

At flagged parameter(s) decision block 1109 and organizing block 1110 remediation system 110 can collect the real-time operation logs data and metrics data to transform the source log file and metrics data to an observatory data pattern data structure as set forth herein with use of one or more data collection profile output responsively to inferencing of trained machine learning model trained from historical operation data.

First and second types of collection engines can be provided. A log monitoring engine can monitor whether a flagged logging data parameter (as referenced in an active data collection profile) is detected in the real-time operation log files. A metric monitoring engine can monitor real-time metrics data to check whether a flagged metrics data parameter value (as referenced in an active data collection profile) is detected in the real time metrics data. If the flagged logging data parameter or flagged metrics data parameter is detected, remediation system can organize at organizing block 1110 current live real time logging data and metrics data into an observatory data pattern data structure conforming to the format of the template anomaly data structure of Table A for comparison (at similarity analysis block 1111) to prior stored anomaly data patterns stored in data repository 108. collection module will find the matched anomaly data profiles with the founded log keys and exceptional metrics from anomaly repository. Next, data collection module will retrieve the collected anomaly log data and anomaly metric data in terms of the matched anomaly data profiles from real-time log data sets and metric data sets and send the collected multiple dimensional anomaly log data and metric data to anomaly correlation module.

In organizing captured logging data and metrics data into an observatory data pattern data structure for comparison to an anomaly data pattern defining a data structure previously stored in anomaly data pattern registry 2125, remediation system 110 can organize the collected data into a data structure format conforming to the format of the template data structure of Table A featuring combined logging data and metrics data. The anomaly data patterns stored in anomaly pattern registry likewise can be organized and structured to feature a data structure conforming the format of the conforming to the format of the template data structure of Table A featuring combined logging data and metrics data. Table E depict an example observatory data pattern data structure that can be organized and output at organizing block 1110.

TABLE E

```
{
  “rootCause”: undefined
  “anomalyName”: “event 234”,
  “anomalyNodes”: [
    {“timeDiff”: “1”,
      “anomalyLogs”: [{
        “logKey”: “SYS001E”,
        “timeStamp”: “08:00:01”,
        “logText”: “System memory utilization is higher than 80%”
      },{
        “logKey”: “CICS001E”,
        “timeStamp”: “08:00:02”,
        “logText”: “CICS region 2 memory utilization is higher than 60%”
      }],
      “anomalyMetrics”: [
        {“metricName”: “memUtil”,
          “metricRange”: [“1.1”, “1.2”],
          “actualValue”: “0.5”,
          “weight”: “0.7”
        }, {
          “metricName”: “cicsUtil”,
          “metricRange”: [“1.1”, “1.2”],
          “actualValue”: “0.5”,
          “weight”: “0.7”
        }, {
          “metricName”: “db2Util”,
          “metricRange”: [“1.1”, “1.2”],
          “actualValue”: “0.4”,
          “weight”: “0.7”
        }]
    }, {
      “timeDiff”: “11s”,
      “anomalyLogs”: [{
        “logKey”: “DB2ERR001”,
        “timeStamp”: “08:00:05”,
        “logText”: “DB2 buffer pool is larger than 80%”
      },{
        “logKey”: “MQERR003”,
        “timeStamp”: “08:00:07”,
        “logText”: “The depth of Queue Q1 is larger than 1000”
      }],
      “anomalyMetrics”: [
        {“metricName”: “db2BufferPool”,
          “metricRange”: [“1.1”, “1.2”],
          “actualValue”: “0.5”,
          “weight”: “0.7”
        }, {
          “metricName”: “queueDepth”,
          “metricRange”: [“1.1”, “1.2”],
          “actualValue”: “0.4”,
          “weight”: “0.7”
        }, {
          “metricName”: “queueRate”,
          “metricRange”: [“1.1”, “1.2”],
          “actualValue”: “0.5”,
          “weight”: “0.7”
        }]
    }]
}
```

Providing an observatory data pattern data structure and an anomaly data pattern to feature a common data format facilitates comparison and matching between one or more observatory data structure and one or more anomaly data pattern at similarity analysis block 1111 and matching block 1112.

An observatory data pattern data structure and an anomaly data pattern can have the same format, to facilitate comparison therebetween. In one embodiment, vector similarity algorithm and/or AI techniques can be used to calculate a comparison score between an observatory data pattern data structure and an anomaly data pattern stored in data repository 108. Vector similarity algorithms can be used to measure the likeness between two vectors in various applications. Common methods can include Cosine Similarity, which can evaluate the cosine of the angle between vectors, and Euclidean Distance, which can calculate the straight-line distance between points in space. Manhattan Distance can sum the absolute differences between vector coordinates, while Jaccard Similarity can compare the intersection and union of sets. Pearson Correlation can assess linear correlation, often used in recommendation systems, and Hamming Distance can count the differing positions between binary vectors. Minkowski Distance can generalize both Euclidean and Manhattan distances, allowing flexibility in distance calculation. Each method can suit different types of data and similarity measurement needs. Remediation system 110 can detect a match when a comparison score between compared entities satisfies a threshold.

On the determination that a current observatory data pattern data structure matches an historical anomaly pattern of anomaly pattern registry 2125, remediation system 110 can proceed to send block 1113 and then to remediation query block 1114. When a current observatory data pattern data structure matches an historical anomaly pattern of anomaly pattern registry 2125, remediation system 110 detects a current anomaly and/or root cause (i.e., the anomaly and/or root cause mapping to the matching anomaly data pattern) currently present in computer environment 200 based on processing of current live real time logging data and/or metrics data.

At send block 1113, for remediation of the anomaly, remediation system 110 can send prompting data to one or more UE device of UE devices 150A-150Z for presentment at present block 1502. The prompting data can include text based prompting data specifying the detected anomaly and/or root cause. The prompting data, by specifying the detected anomaly and/or root cause prompts an administrator to take action that will remediate the detected anomaly. In one embodiment, the prompting data can include text based prompting data that specifies a recommended remediation for remediation of the detected anomaly. Remediation system 110 can determine the recommended remediation data by inferencing remediation optimizing machine learning model 4602 in a manner set forth herein described in reference to FIG. 4B and in reference to processing blocks 1114 and 1115.

At remediation query block 1114, remediation system 110 can perform multiple queries on remediations data volume 2124 as is indicated by receive and respond block 2102. In response to the described queries, remediations data volume 2125 can return one or more recommended remediation. On completion of remediation query block 1114, remediation system 110 can proceed to send block 1114. At send block 1114, remediation system 110 can send command data to implement the one or more remediation within computer system 200 as set forth in FIG. 2.

For storing remediations data in remediations data volume 2124, remediation system 110 can be configured to iteratively train and inference remediation optimizing machine learning model 4602 as shown in FIG. 4B based on accumulated logging and metrics data within volumes 2121 and 2122 that accumulates on an ongoing basis.

Referring to remediation optimizing machine learning model 4602, remediation optimizing machine learning model 4602 can be trained with iterations of training data, and once trained, can be responsive to inferencing data. Training data for training remediation optimizing machine learning model 4602 can include input training data and outcome training data. For each iteration of training data, the input training data can include an anomaly ID associated to an applied remediation ID specifying the applied remediation. The outcome data can be provided by remediation performance observatory data, e.g., metrics data and/or logging data specifying performance of computer environment 200 when remediation has been applied.

Remediation optimizing machine learning model 4602, once trained, can be responsive to inferencing data. Inferencing data for inferencing remediation optimizing machine learning model 4602 can include an anomaly ID associated to an applied remediation ID that is proposed for remediation of a currently detected anomaly having an associated root cause ID. Remediation optimizing machine learning model 4602 when inferenced as described can output predicted performance observatory data associated to the anomaly ID and applied remediation ID applied as inferencing data. Remediation system 110 can rank in an ordered list remediations according to the predicted observatory data and can store remediation data defined by text based data that specifies, as recommended remediations, remediations of the ranked ordered list.

Remediation system 110 can perform the described inferencing using several alternative applied remediation IDs for a given anomaly, each providing a qualitatively different predicted performance observatory data. The remediation performance observatory data applied as training data to remediation optimizing machine learning model 4602 and output as output data responsive to an inferencing can be derived from a set of logging data parameters and/or metrics data parameters and can be expressed as a qualitative value. Commonly observed computer environment anomalies include, e.g., slow system performance, network connectivity issues, system crashes, disk errors, high CPU or memory usage, unresponsive applications, peripheral device malfunctions, software installation failures, and battery or power problems in laptops. Slow system performance often arises from high CPU or memory usage, outdated hardware, excessive background processes, or malware. To remediate slow system performance remediation system 110 can, e.g., close unnecessary applications, run disk cleanup utilities, upgrade hardware, or scan for malware to improve system performance. Network connectivity issues, which may result from faulty hardware, misconfigured settings, DNS problems, or ISP outages, can be remediated by remediation system 110, e.g., restarting routers and computers, checking cable connections, flushing DNS caches, resetting network settings, or contacting the ISP for support. System crashes or the appearance of Blue Screen of Death (BSOD) errors may be caused by driver conflicts, corrupted system files, or overheating, and can be remediated by checking system logs, updating drivers, ensuring proper cooling, running memory diagnostics, and performing system file checks. Disk errors, often stemming from bad sectors or file corruption, can be remediated by remediation system 110, e.g., running disk check utilities such as chkdsk, backing up important data, or replacing a failing hard drive. High CPU or memory usage, which can degrade system performance, may be remediated by remediation system 110, e.g., identifying and closing resource-heavy processes, restarting the system, upgrading memory or the CPU, uninstalling unnecessary programs, or scanning for potential malware infections. When applications become unresponsive, remediation steps can include remediation system 110, e.g., force-closing the application, reinstalling it to fix potential file corruption, updating it to the latest version, or ensuring compatibility with system hardware and software configurations. Peripheral device malfunctions, such as issues with USB drives, printers, or other external devices, can often be remediated by updating drivers, checking connections, switching to alternative ports, or replacing faulty devices. Software installation failures, commonly caused by incompatible system requirements or corrupted installation files, can be remediated by remediation system 110 ensuring the system meets software requirements, running the installation process as an administrator, downloading a new copy of the installation file, or temporarily disabling antivirus software that might interfere with the installation. Finally, battery drain or power issues in laptops, which may arise due to aged batteries, faulty chargers, or incorrect power settings, can be remediated by remediation system 110, e.g., adjusting power settings, closing power-intensive applications, replacing the battery, or verifying that the charger is functioning properly. As noted, remediation system 110 can rank in an ordered list remediations according to the predicted observatory data output by inferencing remediation optimizing machine learning model 4602 and can store remediation data defined by text based data that specifies, as recommended remediations, remediations of the ranked ordered list. The remediations can include, e.g., remediations of the types set forth herein.

On completion of send block 1115, remediation system 110 can proceed to return block 1117. Remediation system 110 can also proceed to return block 1115 on the return of a no decision at decision block 1112. At return block 1117, remediation system 110 can return to stage preceding send block 1101 so that remediation system 110 receives a next iteration of logging and/or metrics data and selection data. Remediation system 110 can iteratively perform the loop of blocks 1101-1117 for a deployment period of remediation system 110.

On completion of send block 1401, data sources 140A-140Z can proceed to return block 1402. At return block 1402, data sources 140A-140Z can return to a stage preceding block 1401. Data sources 140A-140Z can iteratively perform the loop of blocks 1401 to 1402 for a deployment period of data sources 140A-140Z.

UE devices 150A-150Z on completion of send block 1503 can proceed to return block 1504. At return block 1504, UE devices 150A-150Z can return to stage preceding block 1501. UE devices 150A-150Z can iteratively perform the loop of blocks 1501-1504 during a deployment period of UE devices 150A-150Z.

Volumes 2121 to 2124 on completion of receive respond block 2102 can proceed to return block 2103. At return block 2103, volumes 2121 to 2124 can return to stage preceding store block 2101. Volumes 2121 to 2124 can iteratively perform the loop of blocks 2101-2103 during a deployment period of volumes 2121 to 2124.

Anomaly data pattern registry 2124 on completion of receive and respond block 2502 can proceed to return block 2503. At return block 2503, anomaly pattern registry 2125 can return to stage preceding block 2501. Anomaly pattern registry 2125 can iteratively perform the loop of blocks 2501-2503 during a deployment period of anomaly pattern registry 2125.

Data collection profile registry 2126 on completion of receive and respond block 2602, can proceed to return block 2603. At return block 2603, data collection profile registry 2126 can return to stage preceding store block 2601. Data collection profile registry 2126 can iteratively perform the loop of blocks 2601-2603 during a deployment period of data collection profile registry 2126.

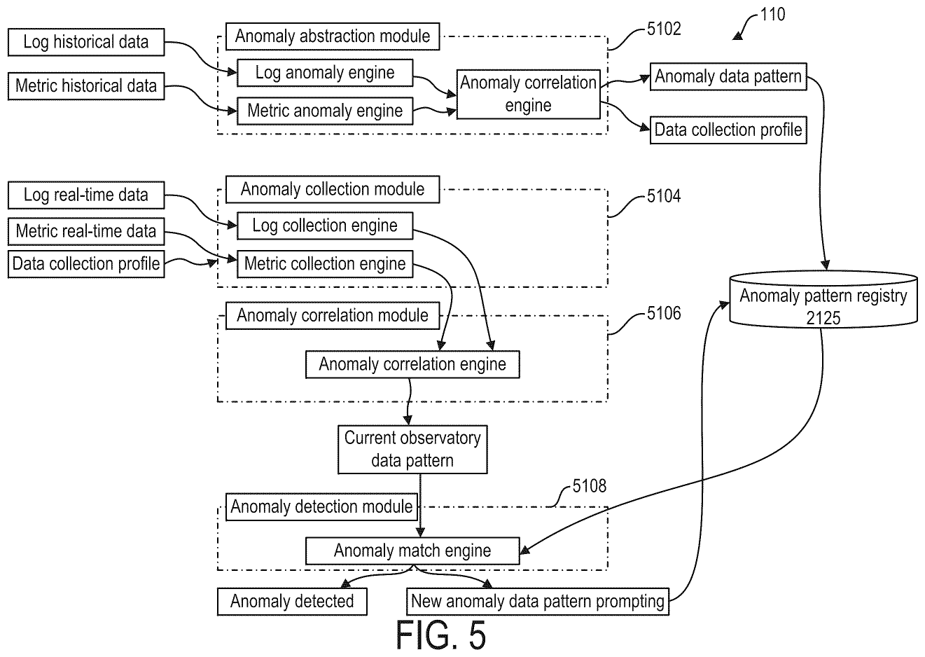

FIG. 5 depicts a functional block diagram of remediation system 110. Remediation system 110 can include an anomaly extraction module 5102 an anomaly collection module 5104 anomaly correlation module 5106 and anomaly detection module 5108. Anomaly extraction module 5102 can include a log anomaly engine, a metric anomaly engine, and an anomaly correlation engine. Anomaly abstraction module 5102 can be defined, according to one embodiment, by anomaly pattern predicting machine learning model 4502 and can receive as input training data log historical data and metric historical data as well as administrator user defined root cause labels as set forth herein. Anomaly abstraction module 5102 can output one or more anomaly data pattern and one or more data collection profile as set forth in reference to inferencing block 1104, testing block 1105 and send block 1107.

Anomaly collection module 5104 can include a logging data collection engine and metric collection engine and can be responsive to log real-time data, metric real-time data, as well as any activated data collection profiles that have been activated by remediation system 110.

Anomaly collection module 5104, according to one embodiment, can be defined by remediation system 110 performing update block 1108 to activate all currently qualified data collection profiles and detection and flag parameter(s) decision block 1109. Anomaly correlation module 5106 can include an anomaly correlation engine and can output a current observatory data pattern. Anomaly correlation module 5106, in one embodiment, can be defined by remediation system 110 performing organizing block 1110. Anomaly detection module 5108 can include an anomaly match engine and can output a detected anomaly or alternatively can output a new anomaly data pattern prompting that prompts an administrator user to take action for generation by remediation system 110 of a new anomaly data pattern.

Anomaly detection module 5108 can be defined by remediation system 110 performing similarity analysis at similarity analysis block 1111 and matching at match block 1112.

In one embodiment, remediation system 110 at match decision block 1112 can ascertain that a span time for a certain data collection profile is expired and no match for current observatory data pattern data structure organized for that data collection profile matches any historical anomaly pattern stored in anomaly pattern registry 2125. In such a situation, remediation system 110, in response to a no decision at match decision block 1112, can send at send block 1116 prompting data to a user interface of UE devices 150A-150Z for presentment at present block 1503 prompting for the generation of a new anomaly data pattern by remediation system 110.

Prompting data sent at send block 1116 can include prompting data including text based prompting data that prompts an administrator user to determine and enter via a user interface an anomaly label and a root cause label data for labeling any unrecognized anomaly detected by failure of matching at match block 1112 associated to the certain current observatory data pattern data structure evaluated at match decision block 1112.

Various available tools, libraries, and/or services can be utilized for implementation of trained machine learning models herein such as predictive model 4502 and/or predictive model 4602. For example, a machine learning service can provide access to libraries and executable code for support of machine learning functions. A machine learning service can provide access to a set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, monitoring and retraining deployed models. According to one possible implementation, a machine learning service can provide access to a set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, monitoring and retraining deployed models. Trained predictive models herein can employ use, e.g., of artificial neural networks (ANNs) support vector machines (SVM), Bayesian networks, and/or other machine learning technologies.

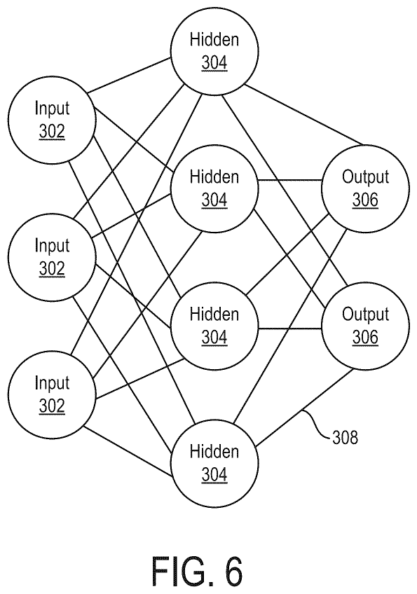

FIG. 6 is an illustration of an example ANN architecture for trained predictive models herein trained by machine learning, such as predictive model 4502 and/or predictive model 4602.

One element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN can be configured for a specific application, such as the applications discussed in connection with machine learning models herein.

Referring now to FIG. 6, a generalized diagram of a neural network is shown. Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

ANNs demonstrate an ability to derive meaning from complicated or imprecise data and can be used to extract patterns and detect trends that are too complex to be detected by humans or other computer-based systems. The structure of a neural network is known generally to have input neurons 302 that provide information to one or more “hidden” neurons 304. Weighted connections 308 between the input neurons 302 and hidden neurons 304 are weighted, and these weighted inputs are then processed by the hidden neurons 304 according to some function in the hidden neurons 304. There can be any number of layers of hidden neurons 304, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 306 accepts and processes weighted input from the last set of hidden neurons 304.

This represents a “feed-forward” computation, where information propagates from input neurons 302 to the output neurons 306. Upon completion of a feed-forward computation, the output is compared to a desired output available from training data. The error relative to the training data is then processed in “backpropagation” computation, where the hidden neurons 304 and input neurons 302 receive information regarding the error propagating backward from the output neurons 306. Once the backward error propagation has been completed, weight updates are performed, with the weighted connections 308 being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output, which can be referred to as outcome training data as referenced in connection with predictive models, e.g., predictive models 4502, 4602 herein. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process can continue until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, weights of weighted connections 308 may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs. Alternatively, weights of weighted connections 308 may be implemented as resistive processing units (RPUs), generating a predictable current output when an input voltage is applied in accordance with a settable resistance.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes. The computer implemented method also includes training a machine learning model with use of supervised learning, where the training includes applying to the machine learning model training data that includes historical logging data and historical metrics data of a computer environment, the training data being labeled with anomaly label data; inferencing the machine learning model for output of a data collection profile, processing current logging data and metrics data of the computer environment in dependence on one or more attribute of the data collection profile, identifying an anomaly of the computer environment in dependence on the processing, and performing an action for remediation of the anomaly. Other embodiments of this aspect include corresponding computer systems, apparatus, and computer programs recorded on one or more computer storage devices, each configured to perform the actions of the methods.

Implementations may include one or more of the following features. The computer implemented method where the historical logging data and historical metrics data of a computer environment define a superset of observatory data parameters, and where the data collection profile references a set of observatory data parameters, where the set of observatory data parameters includes a count of observatory parameters less than a count of observatory data parameters of the superset of observatory data parameters. The training the machine learning model includes performing the training to filter out observatory data parameters of the historical logging data and historical metrics data so that certain observatory data parameters of the historical logging data and historical metrics data are identified by the training, where the data collection profile references the certain observatory data parameters of the historical logging data and historical metrics data, where the processing current logging data and metrics data of the computer environment in dependence on one or more attribute of the data collection profile includes selectively organizing certain observatory data of the current logging data and metrics data in dependence on a determination of the certain observatory data is observatory data of the certain observatory data parameters. The training the machine learning model includes performing the training to filter out observatory data parameters of the historical logging data and historical metrics data so that certain observatory data parameters of the historical logging data and historical metrics data are identified by the training, where the data collection profile references the certain observatory data parameters of the historical logging data and historical metrics data. The data collection profile references a set of observatory data parameters, and where the processing current logging data and metrics data of the computer environment includes determining that current observatory data of the current logging data and metrics data is included in the set of observatory data parameters, responsively organizing the current observatory data into a current observatory data pattern data structure. The inferencing the machine learning model includes inferencing the machine learning model for output of an anomaly data pattern and where the method includes storing the anomaly data pattern into a data repository. The data collection profile references a set of observatory data parameters, and where the processing current logging data and metrics data of the computer environment includes determining that current observatory data of the current logging data and metrics data is included in the set of observatory data parameters, responsively organizing the current observatory data into a current observatory data pattern data structure, and where the inferencing the machine learning model includes inferencing the machine learning model for output of an anomaly data pattern and where the method includes storing the anomaly data pattern into a data repository. The data collection profile references a set of observatory data parameters, and where the processing current logging data and metrics data of the computer environment includes determining that current observatory data of the current logging data and metrics data is included in the set of observatory data parameters, responsively organizing the current observatory data into a current observatory data pattern data structure, where the inferencing the machine learning model includes inferencing the machine learning model for output of an anomaly data pattern and where the method includes storing the anomaly data pattern into a data repository, and method includes determining a similarity between the current observatory data pattern data structure and the anomaly data pattern, where the identifying the anomaly of the computer environment in dependence on the processing includes performing the identifying in dependence on the determining the determining the similarity between the current observatory data pattern data structure and the anomaly data pattern. The performing the action for remediation of the anomaly includes presenting text based data specifying the anomaly. The performing the action for remediation of the anomaly includes presenting text based data specifying the anomaly and a root cause of the anomaly. The performing the action for remediation of the anomaly includes presenting text based data specifying a recommended remediation for remediating the anomaly. The performing the action for remediation of the anomaly includes implementing the remediation in the computer environment. The performing the action for remediation of the anomaly includes retrieving a recommended remediation from a data repository, where the recommended remediation has been determined by inferencing a trained predictive model trained by machine learning with training data that may include performance data of the computer environment observed in response to historical applied remediations applied to the computer environment. Implementations of the described techniques may include hardware, a method or process, or computer software on a computer-accessible medium.

One general aspect includes. The system also includes a memory; at least one processor in communication with the memory; and program instructions executable by one or more processor via the memory to perform operations may include: training a machine learning model with use of supervised learning, where the training includes applying to the machine learning model training data that includes historical logging data and historical metrics data of a computer environment, the training data being labeled with anomaly label data; inferencing the machine learning model for output of a data collection profile; processing current logging data and metrics data of the computer environment in dependence on one or more attribute of the data collection profile; identifying an anomaly of the computer environment in dependence on the processing; and performing an action for remediation of the anomaly. Other embodiments of this aspect include corresponding computer systems, apparatus, and computer programs recorded on one or more computer storage devices, each configured to perform the actions of the methods.

Implementations may include one or more of the following features. The system where the historical logging data and historical metrics data of a computer environment define a superset of observatory data parameters, and where the data collection profile references a set of observatory data parameters, where the set of observatory data parameters includes a count of observatory parameters less than a count of observatory data parameters of the superset of observatory data parameters. The data collection profile references a set of observatory data parameters, and where the processing current logging data and metrics data of the computer environment includes determining that current observatory data of the current logging data and metrics data is included in the set of observatory data parameters, responsively organizing the current observatory data into a current observatory data pattern data structure. The inferencing the machine learning model includes inferencing the machine learning model for output of an anomaly data pattern and where the operations include storing the anomaly data pattern into a data repository. The data collection profile references a set of observatory data parameters, and where the processing current logging data and metrics data of the computer environment includes determining that current observatory data of the current logging data and metrics data is included in the set of observatory data parameters, responsively organizing the current observatory data into a current observatory data pattern data structure, and where the inferencing the machine learning model includes inferencing the machine learning model for output of an anomaly data pattern and where the operations include storing the anomaly data pattern into a data repository. The data collection profile references a set of observatory data parameters, and where the processing current logging data and metrics data of the computer environment includes determining that current observatory data of the current logging data and metrics data is included in the set of observatory data parameters, responsively organizing the current observatory data into a current observatory data pattern data structure, where the inferencing the machine learning model includes inferencing the machine learning model for output of an anomaly data pattern and where the operations include storing the anomaly data pattern into a data repository, and method includes determining a similarity between the current observatory data pattern data structure and the anomaly data pattern, where the identifying the anomaly of the computer environment in dependence on the processing includes performing the identifying in dependence on the determining the determining the similarity between the current observatory data pattern data structure and the anomaly data pattern. Implementations of the described techniques may include hardware, a method or process, or computer software on a computer-accessible medium.

One general aspect includes a computer readable storage medium readable by one or more processing circuit and storing instructions for execution by one or more processor for performing operations may include: The computer program product also includes training a machine learning model with use of supervised learning, where the training includes applying to the machine learning model training data that includes historical logging data and historical metrics data of a computer environment, the training data being labeled with anomaly label data; inferencing the machine learning model for output of a data collection profile, processing current logging data and metrics data of the computer environment in dependence on one or more attribute of the data collection profile, identifying an anomaly of the computer environment in dependence on the processing, and performing an action for remediation of the anomaly. Other embodiments of this aspect include corresponding computer systems, apparatus, and computer programs recorded on one or more computer storage devices, each configured to perform the actions of the methods.

Certain embodiments herein may offer various technical computing advantages involving computing advantages to address problems arising in the realm of computer systems. Embodiments herein facilitate the detection of root causes and anomalies in a computer system with improved accuracy and economized computing resource utilization. Embodiments herein can include training a machine learning model that is trained to isolate selective logging data and metrics data as well as time periods that are most relevant to an observed anomaly having an observed root cause. The described machine learning model, once trained, can be deployed for use in generating anomaly data patterns indicative historical anomalies that have been observed to be present within a computer environment. Current real-time logging data and/or metrics data can be processed using a data collection profile which with an anomaly data pattern can be output by the described machine learning model. Current observatory data patterns cumulated with use of active data collection profiles can be compared to prior anomaly data patterns output by the described machine learning model. The remediation system can ascertain that an anomaly has occurred when a current observatory data pattern accumulated with use of a data collection profile matches an historical anomaly pattern. The remediation system can activate one or more remediation in response to detection of an anomaly. Embodiments herein can include artificial intelligence processing platforms featuring improved processes to transform unstructured data into structured form permitting computer based analytics and decision making. Embodiments herein can include particular arrangements for both collecting rich data into a data repository and additional particular arrangements for updating such data and for use of that data to drive artificial intelligence decision making. Certain embodiments may be implemented by use of a cloud platform/data center in various types including a Software-as-a-Service (SaaS), Platform-as-a-Service (PaaS), Database-as-a-Service (DBaaS), and combinations thereof based on types of subscription.

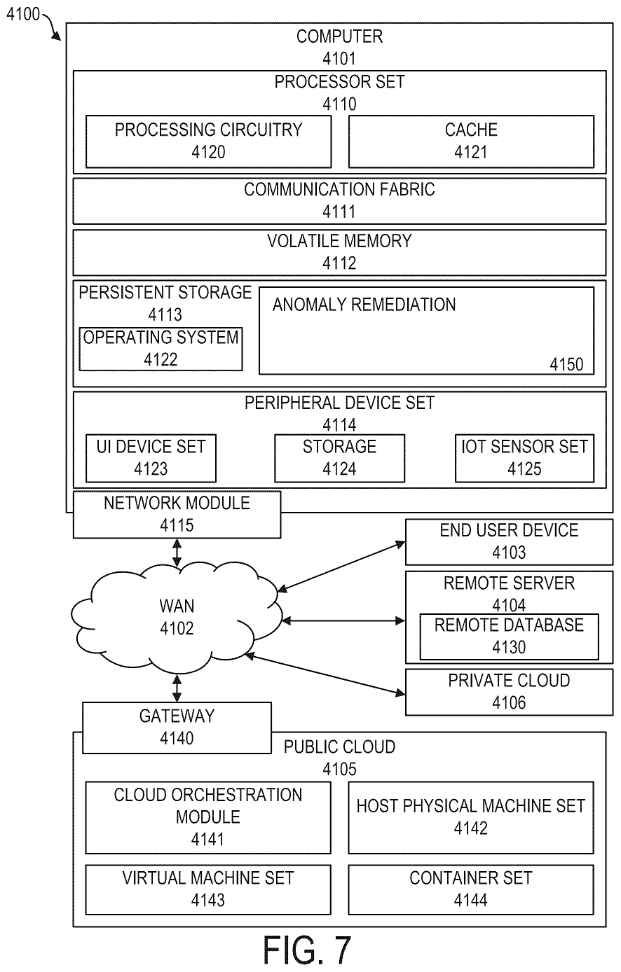

In reference to FIG. 7 there is set forth a description of a computing environment 4100 that can include one or more computer 4101. In one example, computing node 10 as set forth herein can be provided in accordance with computer 4101 as set forth in FIG. 7.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

One example of a computing environment to perform, incorporate and/or use one or more aspects of the present invention is described with reference to FIG. 7. In one aspect, a computing environment 4100 contains an example of an environment for the execution of at least some of the computer code involved in performing the inventive methods, such as code 4150 for performing anomaly remediation processing described with reference to FIGS. 1-6. In addition to block 4150, computing environment 4100 includes, for example, computer 4101, wide area network (WAN) 4102, end user device (EUD) 4103, remote server 4104, public cloud 4105, and private cloud 4106. In this embodiment, computer 4101 includes processor set 4110 (including processing circuitry 4120 and cache 4121), communication fabric 4111, volatile memory 4112, persistent storage 4113 (including operating system 4122 and block 4150, as identified above), peripheral device set 4114 (including user interface (UI) device set 4123, storage 4124, and Internet of Things (IoT) sensor set 4125), and network module 4115. Remote server 4104 includes remote database 4130. Public cloud 4105 includes gateway 4140, cloud orchestration module 4141, host physical machine set 4142, virtual machine set 4143, and container set 4144. IoT sensor set 4125, in one example, can include a Global Positioning Sensor (GPS) device, one or more of a camera, a gyroscope, a temperature sensor, a motion sensor, a humidity sensor, a pulse sensor, a blood pressure (bp) sensor or an audio input device.

Computer 4101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 4130. As is well understood in the art of computer technology, and depending upon the technology, performance of a computer-implemented method may be distributed among multiple computers and/or between multiple locations. On the other hand, in this presentation of computing environment 4100, detailed discussion is focused on a single computer, specifically computer 4101, to keep the presentation as simple as possible. Computer 4101 may be located in a cloud, even though it is not shown in a cloud in FIG. 1. On the other hand, computer 4101 is not required to be in a cloud except to any extent as may be affirmatively indicated.

Processor set 4110 includes one, or more, computer processors of any type now known or to be developed in the future. Processing circuitry 4120 may be distributed over multiple packages, for example, multiple, coordinated integrated circuit chips. Processing circuitry 4120 may implement multiple processor threads and/or multiple processor cores. Cache 4121 is memory that is located in the processor chip package(s) and is typically used for data or code that should be available for rapid access by the threads or cores running on processor set 4110. Cache memories are typically organized into multiple levels depending upon relative proximity to the processing circuitry. Alternatively, some, or all, of the cache for the processor set may be located “off chip.” In some computing environments, processor set 4110 may be designed for working with qubits and performing quantum computing.

Computer readable program instructions are typically loaded onto computer 4101 to cause a series of operational steps to be performed by processor set 4110 of computer 4101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 4121 and the other storage media discussed below. The program instructions, and associated data, are accessed by processor set 4110 to control and direct performance of the inventive methods. In computing environment 4100, at least some of the instructions for performing the inventive methods may be stored in block 4150 in persistent storage 4113.

Communication fabric 4111 is the signal conduction paths that allow the various components of computer 4101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 4112 is any type of volatile memory now known or to be developed in the future. Examples include dynamic type random access memory (RAM) or static type RAM. Typically, the volatile memory is characterized by random access, but this is not required unless affirmatively indicated. In computer 4101, the volatile memory 4112 is located in a single package and is internal to computer 4101, but, alternatively or additionally, the volatile memory may be distributed over multiple packages and/or located externally with respect to computer 4101.

Persistent storage 4113 is any form of non-volatile storage for computers that is now known or to be developed in the future. The non-volatility of this storage means that the stored data is maintained regardless of whether power is being supplied to computer 4101 and/or directly to persistent storage 4113. Persistent storage 4113 may be a read only memory (ROM), but typically at least a portion of the persistent storage allows writing of data, deletion of data and re-writing of data. Some familiar forms of persistent storage include magnetic disks and solid state storage devices. Operating system 4122 may take several forms, such as various known proprietary operating systems or open source. Portable Operating System Interface-type operating systems that employ a kernel. The code included in block 4150 typically includes at least some of the computer code involved in performing the inventive methods.

Peripheral device set 4114 includes the set of peripheral devices of computer 4101. Data communication connections between the peripheral devices and the other components of computer 4101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 4123 may include components such as a display screen, speaker, microphone, wearable devices (such as goggles and smart watches), keyboard, mouse, printer, touchpad, game controllers, and haptic devices. Storage 4124 is external storage, such as an external hard drive, or insertable storage, such as an SD card. Storage 4124 may be persistent and/or volatile. In some embodiments, storage 4124 may take the form of a quantum computing storage device for storing data in the form of qubits. In embodiments where computer 4101 is required to have a large amount of storage (for example, where computer 4101 locally stores and manages a large database) then this storage may be provided by peripheral storage devices designed for storing very large amounts of data, such as a storage area network (SAN) that is shared by multiple, geographically distributed computers. IoT sensor set 4125 is made up of sensors that can be used in Internet of Things applications. For example, one sensor may be a thermometer and another sensor may be a motion detector. A sensor of IoT sensor set 4125 can alternatively or in addition include, e.g., one or more of a camera, a gyroscope, a humidity sensor, a pulse sensor, a blood pressure (bp) sensor or an audio input device.

Network module 4115 is the collection of computer software, hardware, and firmware that allows computer 4101 to communicate with other computers through WAN 4102. Network module 4115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 4115 are performed on the same physical hardware device. In other embodiments (for example, embodiments that utilize software-defined networking (SDN)), the control functions and the forwarding functions of network module 4115 are performed on physically separate devices, such that the control functions manage several different network hardware devices. Computer readable program instructions for performing the inventive methods can typically be downloaded to computer 4101 from an external computer or external storage device through a network adapter card or network interface included in network module 4115.

WAN 4102 is any wide area network (for example, the internet) capable of communicating computer data over non-local distances by any technology for communicating computer data, now known or to be developed in the future. In some embodiments, the WAN 4102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 4103 is any computer system that is used and controlled by an end user (for example, a customer of an enterprise that operates computer 4101), and may take any of the forms discussed above in connection with computer 4101. EUD 4103 typically receives helpful and useful data from the operations of computer 4101. For example, in a hypothetical case where computer 4101 is designed to provide a recommendation to an end user, this recommendation would typically be communicated from network module 4115 of computer 4101 through WAN 4102 to EUD 4103. In this way, EUD 4103 can display, or otherwise present, the recommendation to an end user. In some embodiments, EUD 4103 may be a client device, such as thin client, heavy client, mainframe computer, desktop computer and so on.

Remote server 4104 is any computer system that serves at least some data and/or functionality to computer 4101. Remote server 4104 may be controlled and used by the same entity that operates computer 4101. Remote server 4104 represents the machine(s) that collect and store helpful and useful data for use by other computers, such as computer 4101. For example, in a hypothetical case where computer 4101 is designed and programmed to provide a recommendation based on historical data, then this historical data may be provided to computer 4101 from remote database 4130 of remote server 4104.

Public cloud 4105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 4105 is performed by the computer hardware and/or software of cloud orchestration module 4141. The computing resources provided by public cloud 4105 are typically implemented by virtual computing environments that run on various computers making up the computers of host physical machine set 4142, which is the universe of physical computers in and/or available to public cloud 4105. The virtual computing environments (VCEs) typically take the form of virtual machines from virtual machine set 4143 and/or containers from container set 4144. It is understood that these VCEs may be stored as images and may be transferred among and between the various physical machine hosts, either as images or after instantiation of the VCE. Cloud orchestration module 4141 manages the transfer and storage of images, deploys new instantiations of VCEs and manages active instantiations of VCE deployments. Gateway 4140 is the collection of computer software, hardware, and firmware that allows public cloud 4105 to communicate through WAN 4102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 4106 is similar to public cloud 4105, except that the computing resources are only available for use by a single enterprise. While private cloud 4106 is depicted as being in communication with WAN 4102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 4105 and private cloud 4106 are both part of a larger hybrid cloud.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements but is not limited to possessing only those one or more steps or elements. Likewise, a step of a method or an element of a device that “comprises,” “has,” “includes,” or “contains” one or more features possesses those one or more features, but is not limited to possessing only those one or more features. Forms of the term “based on” herein encompass relationships where an element is partially based on as well as relationships where an element is entirely based on. Methods, products and systems described as having a certain number of elements can be practiced with less than or greater than the certain number of elements. Furthermore, a device or structure that is configured in a certain way is configured in at least that way but may also be configured in ways that are not listed.

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A computer implemented method comprising:
training a machine learning model with use of supervised learning, wherein the training includes applying to the machine learning model training data that includes historical logging data and historical metrics data of a computer environment, the training data being labeled with anomaly label data;
inferencing the machine learning model for output of a data collection profile;
processing current logging data and metrics data of the computer environment in dependence on one or more attribute of the data collection profile;
identifying an anomaly of the computer environment in dependence on the processing; and
performing an action for remediation of the anomaly.

2. The computer implemented method of claim 1, wherein the historical logging data and historical metrics data of a computer environment define a superset of observatory data parameters, and wherein the data collection profile references a set of observatory data parameters, wherein the set of observatory data parameters includes a count of observatory parameters less than a count of observatory data parameters of the superset of observatory data parameters.

3. The computer implemented method of claim 1, wherein the training the machine learning model includes performing the training to filter out observatory data parameters of the historical logging data and historical metrics data so that certain observatory data parameters of the historical logging data and historical metrics data are identified by the training, wherein the data collection profile references the certain observatory data parameters of the historical logging data and historical metrics data, wherein the processing current logging data and metrics data of the computer environment in dependence on one or more attribute of the data collection profile includes selectively organizing certain observatory data of the current logging data and metrics data in dependence on a determination of the certain observatory data is observatory data of the certain observatory data parameters.

4. The computer implemented method of claim 1, wherein the training the machine learning model includes performing the training to filter out observatory data parameters of the historical logging data and historical metrics data so that certain observatory data parameters of the historical logging data and historical metrics data are identified by the training, wherein the data collection profile references the certain observatory data parameters of the historical logging data and historical metrics data.

5. The computer implemented method of claim 1, wherein the data collection profile references a set of observatory data parameters, and wherein the processing current logging data and metrics data of the computer environment includes determining that current observatory data of the current logging data and metrics data is included in the set of observatory data parameters, responsively organizing the current observatory data into a current observatory data pattern data structure.

6. The computer implemented method of claim 1, wherein the inferencing the machine learning model includes inferencing the machine learning model for output of an anomaly data pattern and wherein the method includes storing the anomaly data pattern into a data repository.

7. The computer implemented method of claim 1, wherein the data collection profile references a set of observatory data parameters, and wherein the processing current logging data and metrics data of the computer environment includes determining that current observatory data of the current logging data and metrics data is included in the set of observatory data parameters, responsively organizing the current observatory data into a current observatory data pattern data structure, and wherein the inferencing the machine learning model includes inferencing the machine learning model for output of an anomaly data pattern and wherein the method includes storing the anomaly data pattern into a data repository.

8. The computer implemented method of claim 1, wherein the data collection profile references a set of observatory data parameters, and wherein the processing current logging data and metrics data of the computer environment includes determining that current observatory data of the current logging data and metrics data is included in the set of observatory data parameters, responsively organizing the current observatory data into a current observatory data pattern data structure, wherein the inferencing the machine learning model includes inferencing the machine learning model for output of an anomaly data pattern and wherein the method includes storing the anomaly data pattern into a data repository, and method includes determining a similarity between the current observatory data pattern data structure and the anomaly data pattern, wherein the identifying the anomaly of the computer environment in dependence on the processing includes performing the identifying in dependence on the determining the determining the similarity between the current observatory data pattern data structure and the anomaly data pattern.

9. The computer implemented method of claim 1, wherein the performing the action for remediation of the anomaly includes presenting text based data specifying the anomaly.

10. The computer implemented method of claim 1, wherein the performing the action for remediation of the anomaly includes presenting text based data specifying the anomaly and a root cause of the anomaly.

11. The computer implemented method of claim 1, wherein the performing the action for remediation of the anomaly includes presenting text based data specifying a recommended remediation for remediating the anomaly.

12. The computer implemented method of claim 1, wherein the performing the action for remediation of the anomaly includes implementing the remediation in the computer environment.

13. The computer implemented method of claim 1, wherein the performing the action for remediation of the anomaly includes retrieving a recommended remediation from a data repository, wherein the recommended remediation has been determined by inferencing a trained predictive model trained by machine learning with training data that comprises performance data of the computer environment observed in response to historical applied remediations applied to the computer environment.

14. A system comprising:
a memory;
at least one processor in communication with the memory; and
program instructions executable by one or more processor via the memory to perform operations comprising:
training a machine learning model with use of supervised learning, wherein the training includes applying to the machine learning model training data that includes historical logging data and historical metrics data of a computer environment, the training data being labeled with anomaly label data;
inferencing the machine learning model for output of a data collection profile;
processing current logging data and metrics data of the computer environment in dependence on one or more attribute of the data collection profile;
identifying an anomaly of the computer environment in dependence on the processing; and
performing an action for remediation of the anomaly.

15. The system of claim 14, wherein the historical logging data and historical metrics data of a computer environment define a superset of observatory data parameters, and wherein the data collection profile references a set of observatory data parameters, wherein the set of observatory data parameters includes a count of observatory parameters less than a count of observatory data parameters of the superset of observatory data parameters.

16. The system of claim 14, wherein the data collection profile references a set of observatory data parameters, and wherein the processing current logging data and metrics data of the computer environment includes determining that current observatory data of the current logging data and metrics data is included in the set of observatory data parameters, responsively organizing the current observatory data into a current observatory data pattern data structure.

17. The system of claim 14, wherein the inferencing the machine learning model includes inferencing the machine learning model for output of an anomaly data pattern and wherein the operations include storing the anomaly data pattern into a data repository.

18. The system of claim 14, wherein the data collection profile references a set of observatory data parameters, and wherein the processing current logging data and metrics data of the computer environment includes determining that current observatory data of the current logging data and metrics data is included in the set of observatory data parameters, responsively organizing the current observatory data into a current observatory data pattern data structure, and wherein the inferencing the machine learning model includes inferencing the machine learning model for output of an anomaly data pattern and wherein the operations include storing the anomaly data pattern into a data repository.

19. The system of claim 14, wherein the data collection profile references a set of observatory data parameters, and wherein the processing current logging data and metrics data of the computer environment includes determining that current observatory data of the current logging data and metrics data is included in the set of observatory data parameters, responsively organizing the current observatory data into a current observatory data pattern data structure, wherein the inferencing the machine learning model includes inferencing the machine learning model for output of an anomaly data pattern and wherein the operations include storing the anomaly data pattern into a data repository, and method includes determining a similarity between the current observatory data pattern data structure and the anomaly data pattern, wherein the identifying the anomaly of the computer environment in dependence on the processing includes performing the identifying in dependence on the determining the determining the similarity between the current observatory data pattern data structure and the anomaly data pattern.

20. A computer program product comprising:
a computer readable storage medium readable by one or more processing circuit and storing instructions for execution by one or more processor for performing operations comprising:
training a machine learning model with use of supervised learning, wherein the training includes applying to the machine learning model training data that includes historical logging data and historical metrics data of a computer environment, the training data being labeled with anomaly label data;
inferencing the machine learning model for output of a data collection profile;
processing current logging data and metrics data of the computer environment in dependence on one or more attribute of the data collection profile;
identifying an anomaly of the computer environment in dependence on the processing; and
performing an action for remediation of the anomaly.
